(19) United States
(12) Patent Application Publication
(10) Pub. No.: US 2010/0128308 A1
(43) Pub. Date: May 27, 2010

(54) HOST APPARATUS CONNECTED TO IMAGE FORMING APPARATUS, IMAGE FORMING SYSTEM HAVING THE SAME, AND REMAINING-DEVELOPER DISPLAY METHOD

(75) Inventors: Ji-min PARK, Yongin-si (KR); Un-sik Byun, Seoul (KR); Sung-man Shin, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/606,342

(22) Filed: Oct. 27, 2009

(30) Foreign Application Priority Data
Nov. 27, 2008 (KR) 10-2008-0118546

(51) Int. Cl. G06F 3/12

(52) U.S. Cl. 358/1.15

(57) ABSTRACT

Disclosed are a host apparatus connecting with an image forming apparatus, an image forming system having the same, and a remaining-developer display method. The remaining-developer display method in a host apparatus connectable with at least one image forming apparatus, the method comprising: receiving remaining-developer information from the at least one image forming apparatus; selecting at least one among sorting items displayed corresponding to the received remaining-developer information as a reference item; and arranging and displaying the remaining-developer information with reference to the selected reference item. With this, remaining-developer information are dynamically arranged and displayed with regard to at least one image forming apparatus, so that a user can easily grasp the amount of the remaining-developer at a glance.

### CROSS-REFERENCE TO RELATED APPLICATION

This application claims the benefit of Korean Application No. 10-2008-0118546, filed in the Korean Intellectual Property Office on Nov. 27, 2008, the disclosure of which is incorporated herein by reference.

### BACKGROUND OF THE INVENTION

1. Field of the Invention

Aspects of the present invention relate to a host apparatus connecting with an image forming apparatus, an image forming system having the same, and a remaining-developer display method, and more particularly, to a host apparatus capable of arranging and displaying remaining-developer information of at least one image forming apparatus, an image forming system having the same, and a remaining-developer display method.

2. Description of the Related Art

An image forming apparatus forms an image to be printed on paper. Image forming apparatuses include printers, copying machines, facsimile machines, multi-function peripherals having two or more functions, and the like. Recently, a demand for an office automation system in which the image forming apparatus performs the functions of the scanner, the facsimile, etc. as well as a function of printing a document like a multi-function peripheral has been on the rise. Accordingly, the image forming apparatus has been gradually developed to have higher performance, thereby extending its effective functions.

To more effectively administer the image forming apparatus having the various functions in an image forming system including an administration server connecting with at least one image forming apparatus via a network, a user (or an administrator) accesses the administration server and carries out various settings and administration for the image forming apparatus through a personal computer (PC) or other host apparatus. The user may access the administration server through the host apparatus and refer to information about the image forming apparatus, such as a remaining amount of a developer, including toner, ink, etc.

A color-type image forming apparatus provides information about remaining developer according to the multiple colors. However, a conventional image forming system arranges and displays the remaining-developer information corresponding to colors just according to the image forming apparatuses. Consequently, it is inconvenient for a user to refer to and check the arranged remaining-developer information corresponding to colors one by one when checking a color that the developer needing replacement among the developers has with regard to the plurality of image forming apparatuses.

### SUMMARY OF THE INVENTION

Accordingly, aspects of the present invention provide a host apparatus connecting with an image forming apparatus, an image forming system having the same and a remaining-developer display method, in which remaining-developer information are dynamically arranged and displayed with regard to at least one image forming apparatus, so that a user can grasp the amount of the remaining-developer at a glance.

According to an aspect of the present invention, a method of displaying a remaining-developer in a host apparatus connectable with at least one image forming apparatus is provided. The method includes: receiving remaining-developer information about the at least one image forming apparatus; selecting one or more sorting items displayed corresponding to the received remaining-developer information as a reference item; and arranging and displaying the remaining-developer information with reference to the selected reference item.

According to another aspect of the present invention, the arranging and displaying of the remaining-developer information may include displaying the remaining-developer information sorted according to the sorting items as a column.

According to another aspect of the present invention, the arranging and displaying of the remaining-developer information may include arranging and displaying the remaining-developer information in ascending or descending order with reference to the selected reference item.

According to another aspect of the present invention, the sorting item may include four or more colors.

According to another aspect of the present invention, the receiving of the remaining-developer information about the at least one image forming apparatus may include accessing a device administration server in which the remaining-developer information of the at least one image forming apparatus is stored, and receiving the remaining-developer information from the device administration server.

According to another aspect of the present invention, the method may further include selecting one or more of the sorting items as a filtering item, wherein the arranging and displaying the remaining-developer information may include filtering off the selected filtering item.

According to another aspect of the present invention, the method may further include adding or deleting one or more of the sorting items of the remaining-developer information.

According to another aspect of the present invention, the method may further include transmitting information about ordering a cartridge corresponding to color of a developer needing replacement based on the displayed remaining-developer information.

According to another aspect of the present invention, a host apparatus connectable with at least one image forming apparatus is provided. The host apparatus includes: a communication unit to receive remaining-developer information about the at least one image forming apparatus; a user interface through which one or more sorting items displayed corresponding to the received remaining-developer information are selected as a reference item; a display unit to display the received remaining-developer information; and a controller to control the display unit to arrange and display the remaining-developer information with reference to the selected reference item.

According to another aspect of the present invention, the display unit may display the remaining-developer information sorted according to the sorting items as a column.

According to another aspect of the present invention, the display unit may arrange and display the remaining-developer information in ascending or descending order with reference to the selected reference item.

According to another aspect of the present invention, the communication unit may access a device administration server in which the remaining-developer information of the at least one image forming apparatus is stored, and receive the remaining-developer information from the device administration server.

According to another aspect of the present invention, one or more of the sorting items is selected as a filtering item via the user interface, and the display unit may display the remaining-developer information by filtering off the selected filtering item.

According to another aspect of the present invention, one or more of the sorting items of the remaining-developer information may be added or deleted via the user interface.

According to another aspect of the present invention, the communication unit may transmit information about ordering a cartridge corresponding to a color of a developer needing replacement based on the displayed remaining-developer information.

According to another aspect of the present invention, an image forming system is provided, including at least one image forming apparatus, a device administration server, and a host apparatus. The device administration server may include: a first communication unit to communicate with the image forming apparatus and the host apparatus; a storage unit; and a first controller to receive remaining-developer information from the at least one image forming apparatus and to store the remaining-developer information in the storage unit. The host apparatus may include: a second communication unit to access the device administration server and to receive the remaining-developer information about the at least one image forming apparatus from the device administration server; a user interface through which one or more sorting items are displayed corresponding to the received remaining-developer information as a reference item; a display unit to display the received remaining-developer information; and a second controller to control the display unit to arrange and display the remaining-developer information with respect to the selected reference item.

According to another aspect of the present invention, an image forming system is provided, including at least one image forming apparatus and a host apparatus. The host apparatus may include: a communication unit to receives remaining-developer information from the at least one image forming apparatus; a user interface through which one or more sorting items are displayed corresponding to the received remaining-developer information as a reference item; a display unit to display the received remaining-developer information; and a controller to control the display unit to arrange and display the remaining-developer information with respect to the selected reference item.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows a configuration of an image forming system according to an embodiment of the present invention;

FIG. 2 shows a configuration of a host apparatus according to an embodiment of the present invention;

FIG. 3 shows remaining developer display screen according to an embodiment of the present invention;

FIGS. 4A-4I show examples of a cartridge column arranged with respect to a reference item;

FIG. 5 shows a remaining developer display screen according to an embodiment of the present invention;

FIG. 6 shows a configuration of an image forming system according to an embodiment of the present invention; and

FIG. 7 is a flowchart of a remaining-developer display method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

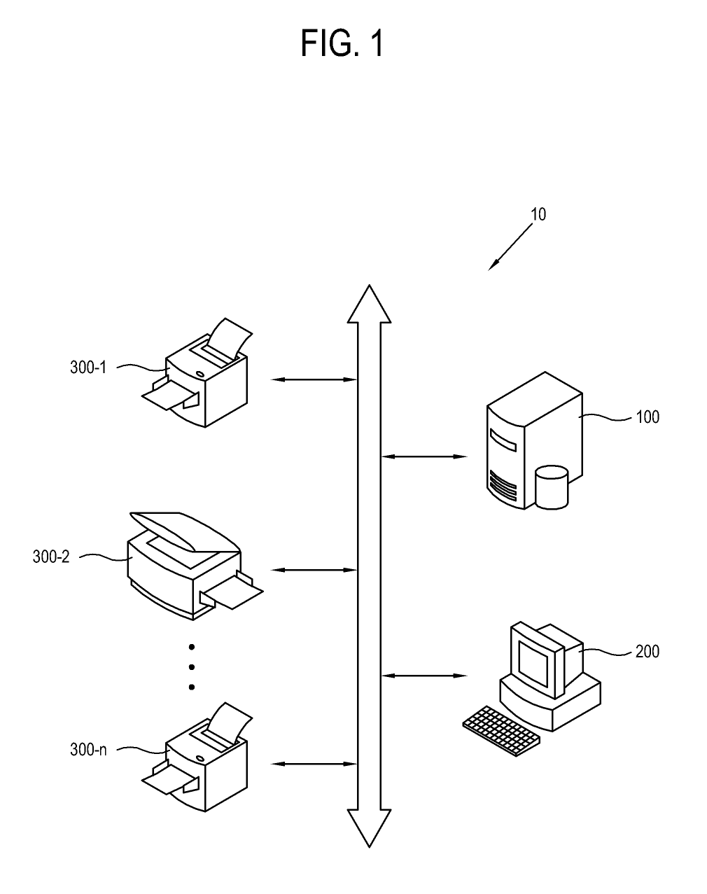

FIG. 1 shows a configuration of an image forming system according to an embodiment of the present invention. An image forming system 10 includes a device administration server 100, a host apparatus 200, and at least one image forming apparatus 300-1, 300-2, . . . , 300-n. The image forming system 10 may include additional components not shown.

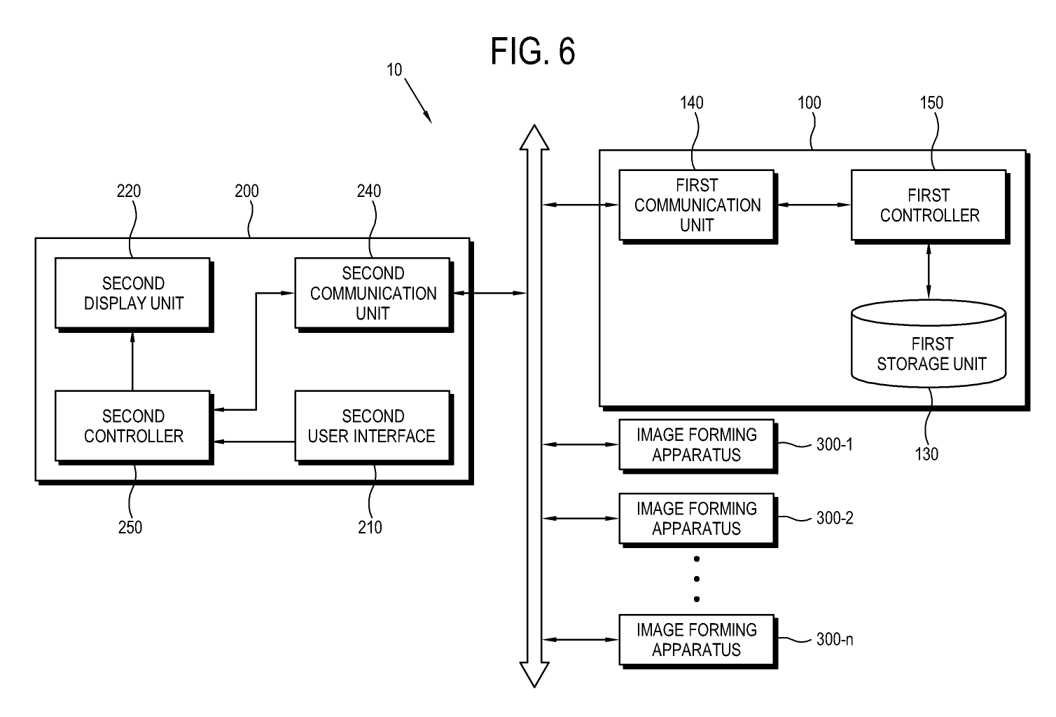

The device administration server 100 includes a storage unit 130 (such as the storage unit shown in FIG. 6) that stores remaining-developer information received from at least one image forming apparatus 300-1, 300-2, . . . , 300-n. A user (or an administrator) accesses the device administration server 100 through the host apparatus 200, thereby checking the remaining-developer information according to the image forming apparatuses 300-1, 300-2, . . . , 300-n, respectively. The developer includes a toner, ink or the like, in which the toner or the ink may correspond to mono color or many colors.

The device administration server 100 makes a request for the remaining-developer information to at least one image forming apparatus 300-1, 300-2, . . . , 300-n at predetermined periods or randomly, and stores the remaining-developer information received in response to the request according to the image forming apparatuses 300-1, 300-2, . . . , 300-n, respectively. The storage unit 130 of the device administration server 100 stores identification information (e.g., a serial number, an internet protocol (IP) address, etc.) about at least one image forming apparatus 300-1, 300-2, . . . , 300-n, and the remaining-developer information so that the identification information and the remaining-developer information can be arranged.

The device administration server 100 may be achieved by an application server in which an application for administrating the connectable image forming apparatuses 300-1, 300-2, . . . , 300-n or a solution distributed as software by an image forming apparatus's manufacturer is installed and executed. The host apparatus 200 may be a personal computer (PC) or the like, and accesses the device administration server 100 to show a user the remaining-developer information of the image forming apparatus 300-1, 300-2, . . . , 300-n.

The device administration server 100 may include a web server. If the device administration server 100 includes the web server, the host apparatus 100 accesses the web server and shows the user the remaining-developer information of the image forming apparatus 300-1, 300-2, . . . , 300-n through a web browser. The image forming apparatus 300-1, 300-2, . . . , 300-n may include a printer, a copying machine, a facsimile machine, a multi-function peripheral having two or more functions, etc.

According to another aspect of the present invention, the host apparatus 200 may directly access at least one image forming apparatus 300-1, 300-2, . . . , 300-n without a separate device administration server 100, and receive the remaining-developer information to thereby show a user the remaining-developer information. In this case, an application for accessing at least one image forming apparatus 300-1, 300-2, . . . , 300-n and receiving and displaying various information is installed in the host apparatus 200. The host apparatus 200 may include the device administration server 100.

If the host apparatus 200 includes the device administration server 100, the host apparatus 200 is connected to at least one image forming apparatus 300-1, 300-2, . . . , 300-n through a wired/wireless network, and receives the remaining-developer information from each image forming apparatus 300-1, 300-2, . . . , 300-n.

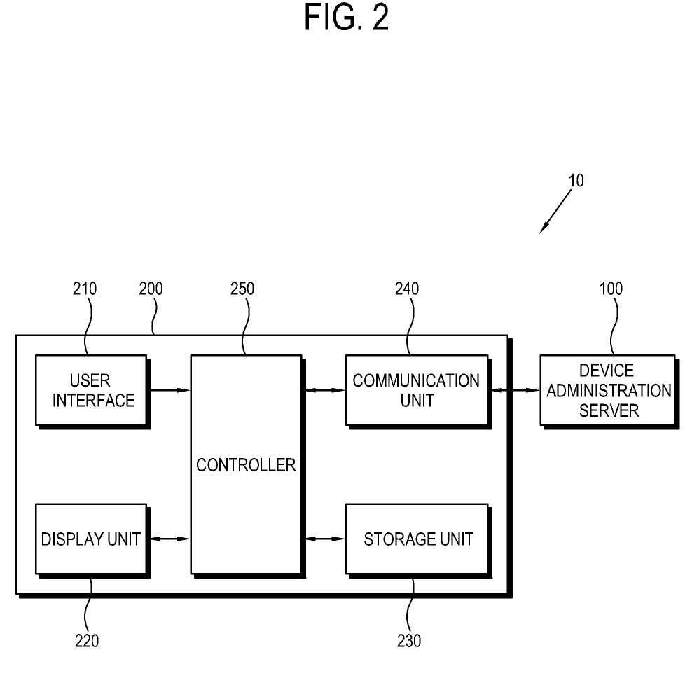

FIG. 2 shows a configuration of a host apparatus according to an embodiment of the present invention. The host apparatus 200 as shown in FIG. 2 connects with the device administration server 100 through the wired/wireless network, and performs data communication with the device administration server 100.

As shown in FIG. 2, the host apparatus 200 includes a user interface 210, a display unit 220, a storage unit 230, a communication unit 240, and a controller 250. According to other aspects of the present invention, the host apparatus 200 may include different and/or additional units. Similarly, the functionality of two or more of the above units may be integrated into a single component.

The user interface 210 allows a user to input various commands. The user may access at least one device administration server 100 through the user interface 210, and remotely input a command to arrange the remaining-developer information. To this end, a user (or an administrator) inputs identification (ID) and a password for login through the user interface 210. The ID and password input by a user are transmitted to the device administration server 100, and the device administration server 100 authenticates the relevant user. Correspondingly, the host apparatus 200 of which a user is authenticated accesses the device administration server 100 and displays the remaining-developer information to a user.

The user interface 210 includes a keyboard, a mouse, etc., provided as an input unit of the host apparatus 200. The user interface 210 may also include a graphical user interface (GUI) generated by executing a driver or a separate application and displayed on the display unit 220 to thereby allow the user's input.

The display unit 220 displays the remaining-developer information corresponding to each image forming apparatus 300-1, 300-2, . . . , 300-n received from the device administration server 100 to a user according to sorting items (categories). The user may select one of the sorting items as a reference item through the user interface 210 to arrange the displayed remaining-developer information. The display unit 220 arranges the remaining-developer information with respect to the selected reference item, and shows the remaining-developer information to the user. The sort item for the remaining-developer information may include a color of the developer, and the developer may include a toner, ink, or other consumable needed by the image forming apparatuses 300. The display unit 220 may include a liquid crystal display (LCD), and a driver (not shown) to drive the LCD.

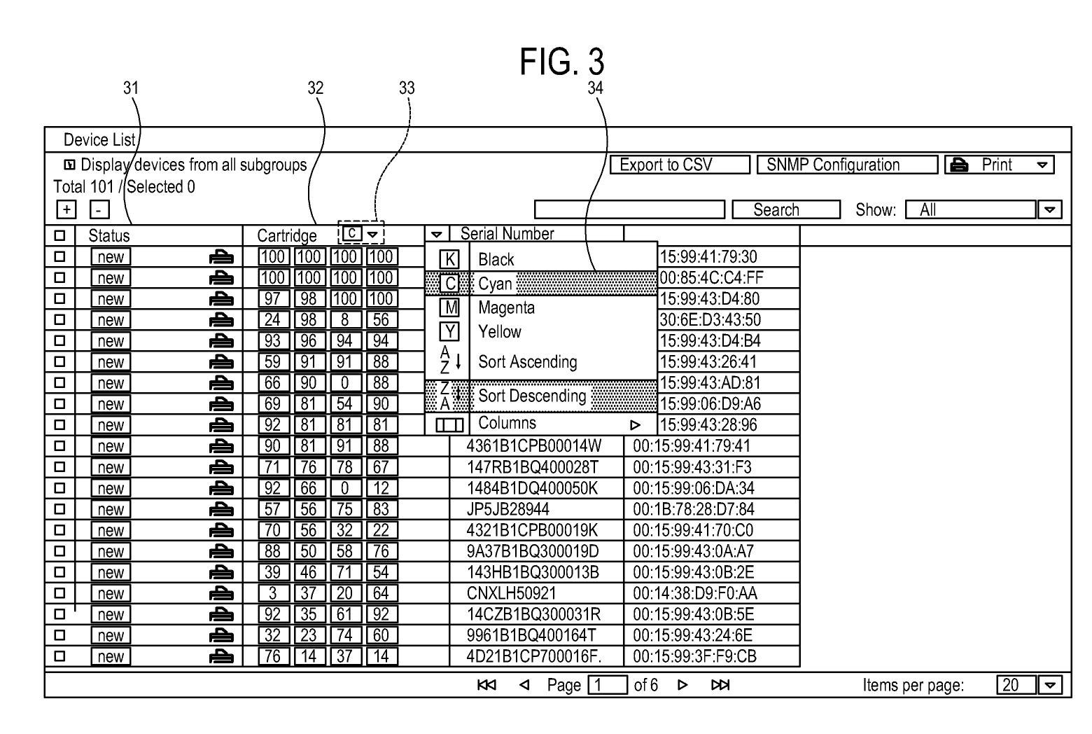

FIG. 3 shows a remaining-developer display screen according to an embodiment of the present invention. As shown in FIG. 3, a remaining-developer display screen 30 shows the remaining-developer information corresponding to at least one image forming apparatus 300-1, 300-2, . . . , 300-n. The remaining-developer display screen 30 shows a list 31 of at least one image forming apparatus 300-1, 300-2, . . . , 300-n, and shows the remaining-developer information of each image forming apparatus 300-1, 300-2, . . . , 300-n according to colors as one cartridge column to a user.

The cartridge column 32 providing a user the remaining-developer information according to colors may show a user an arranging reference 32 of the current remaining-developer information. For example, in FIG. 3, the remaining-developer information according to colors are arranged in descending order with regard to Cyan (C).

The cartridge column 32 includes the remaining-developer information with regard to a plurality of colors in one cell (field). As shown in FIG. 3, the remaining-developer information according to the plurality of colors are shown to a user as a cell (field) including the remaining-developer information as a column. Accordingly, the remaining-developer information according to the plurality of colors are dynamically arranged in a column with respect to a predetermined arranging reference.

The user may select one of the sorting items for the remaining-developer information, i.e., the plurality of colors (C, M, Y and K) as the reference item through the user interface 210. To this end, the remaining-developer display screen 30 includes a dropdown window 34 allowing a user to select the reference item in the cartridge column 32 providing him/her the remaining-developer information according to colors. The user may select at least one reference item through the dropdown window 34. The user may select one of the colors C, M, Y and K as the reference item through the dropdown window 34 of FIG. 3, and select whether to arrange the remaining-developer information with respect to the reference item in ascending order or descending order.

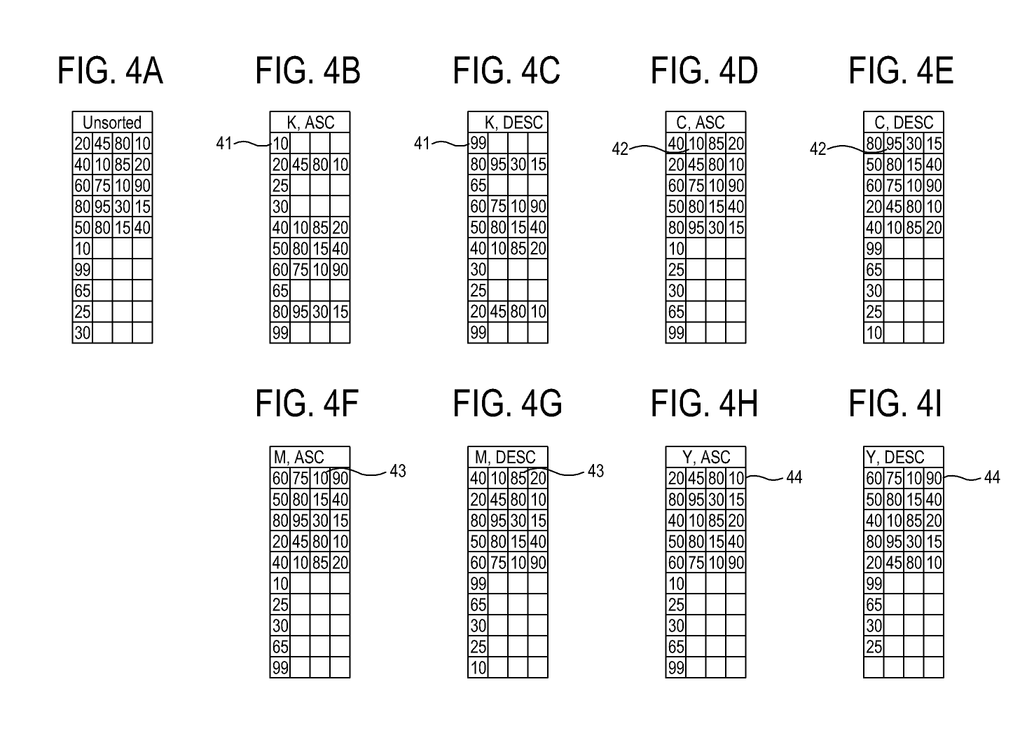

FIGS. 4A-4I show examples of the cartridge column arranged with respect to the reference item selected in the dropdown window 34 of FIG. 3. In FIG. 4A, the remaining-developer information according to colors are displayed according to the image forming apparatus 300-1, 300-2, . . . , 300-n without arrangement.

In FIG. 4B the remaining-developer information according to colors are arranged in the ascending order Δ with respect to black (K) 41. In contrast, in FIG. 4C, the remaining-developer information according to colors are arranged in the descending order ∇ with respect to black (K) 41.

In FIG. 4D the remaining-developer information according to colors are arranged in the ascending order Δ with respect to cyan (C) 42. In contrast, in FIG. 4E the remaining-developer information according to colors are arranged in the descending order ∇ with respect to cyan (C) 42.

In FIG. 4F the remaining-developer information according to colors are arranged in the ascending order Δ with respect to magenta (M) 43. In (g) of FIG. 4G the remaining-developer information according to colors are arranged in the descending order ∇ with respect to magenta (M) 43.

In FIG. 4H, the remaining-developer information according to colors are arranged in the ascending order Δ with respect to yellow (Y) 44. Finally, in FIG. 4I the remaining-developer information according to colors are arranged in the descending order ∇ with respect to yellow (Y) 44.

The host apparatus 200 allows a user to grasp the remaining-developer information corresponding to colors according to the image forming apparatuses 300-1, 300-2, . . . , 300-n at a glance through the dynamic arranging reference. Even though the image forming apparatuses 300-1, 300-2, . . . , 300-n type of mono color and various colors are irregularly jumbled, it is possible to dynamically arrange the image forming apparatuses 300-1, 300-2, . . . , 300-n like FIGS. 4 and 4B.

As described above, one among four colors C, M, Y and K is selected as the reference for arranging the remaining-developer information by way of example, but not limited thereto. Alternatively, one among six, eight or nine colors may be selected as a reference item, or two or more colors may be selected as reference items.

For example, in the case of six colors, light cyan (Lc) and light magenta (Lm) may be added to four colors C, M, Y and K, and one of six colors may be selected as the reference. In the case of eight colors, one among eight colors C, M, Y, K, Lc, Lm, green (Gr) and orange (Or) may be selected as the reference. In the case of nine colors, one among eight colors C, M, Y, K, Lc, Lm, photo blue (B), light gray (Lg) and dark gray (G) may be selected as the reference.

The user may select an export button 35 in the remaining-developer display screen 30, so that the remaining-developer information dynamically arranged with respect to a predetermined reference can be converted into a file having a predetermined format (e.g., CSV, XLS, etc.) and stored in a designated location, or transmitted to the outside such as the device administration server 100.

In addition to the remaining-developer information according to colors, any information can be dynamically arranged, as long as the information has a plurality of attributes according to the image forming apparatuses 300-1, 300-2, . . . , 300-n. For example, sheet number information or the like corresponding to functions such as copying, printing, facsimile, etc. may be displayed in a column according to image forming apparatuses 300-1, 300-2, . . . , 300-n, and one of the functions is selected as the reference item. Thus, the sheet number information may be arranged and displayed in ascending or descending order with respect to the selected reference item.

The host apparatus 200 may select one or more of the sorting items of the displayed remaining-developer information as a filtering item, and control the display unit 220 to display the remaining-developer information by filtering off the selected filtering item. The host apparatus 200 may add or delete at least one of the sorting items. For example, the host apparatus 200 may delete the serial numbers of the image forming apparatuses 300-1, 300-2, . . . , 300-n from the remaining-developer display screen 30 of FIG. 3, or add information about users allowed to use the image forming apparatus 300-1, 300-2, . . . , 300-n to the remaining-developer display screen 30.

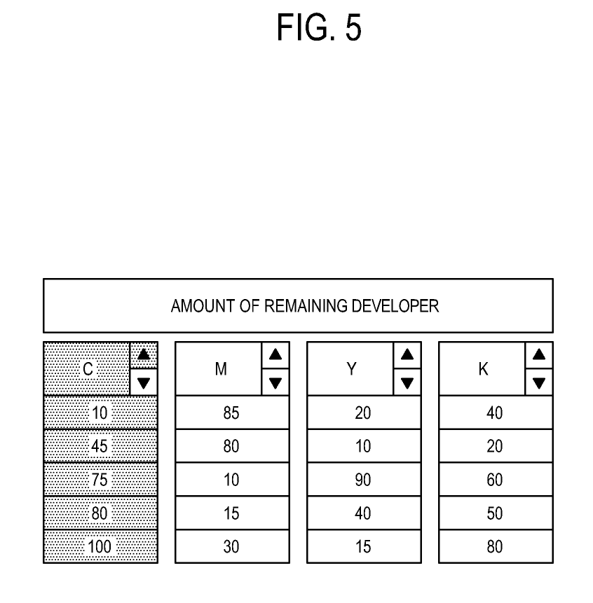

The host apparatus 200 may merge a plurality of cells according to a user's selection. For example, as shown in FIG. 5, the remaining-developer information corresponding to each color C, M, Y and K is displayed as a separate column, and the cells where upper items are displayed are merged to thereby allow the user to easily check the remaining-developer information. Thus, in the case that the plural cells are merged, the remaining-developer information can be arranged dynamically with respect to one reference. The host apparatus 200 may select a plurality of image forming apparatuses in the remaining-developer display screen 30, and arrange and display only the selected image forming apparatus with respect to a predetermined reference item.

The remaining-developer information arranged with respect to a predetermined item can be stored in the storage unit 230. Specifically, the storage unit 230 may store the remaining-developer information arranged and displayed with respect to the selected reference item as a temporary file at a predetermined location. This operation of storing the temporary file may be performed when the dynamic arrangement of the remaining-developer information is sensed, or may be performed periodically or randomly.

The storage unit 230 may include an internal storage medium, such as a hard disk drive (HDD); or an external or portable storage medium, such as a universal serial bus (USB) memory or a memory card. Examples of memory cards include memory sticks, compact flash (CF) cards, and multimedia cards (MMC).

The communication unit 240 performs wired/wireless communication with the device administration server 100 that stores the remaining-developer information about at least one image forming apparatus 300-1, 300-2, . . . , 300-n. The communication unit 240 accesses the device administration server 100 and receives the remaining-developer information about the image forming apparatus 300-1, 300-2, . . . , 300-n.

The communication unit 240 may include a wired/wireless communication module connectable with the device administration server 100 locally or through a network based on a predetermined protocol, or a USB port or the like connectable with the portable storage medium.

As necessary, the host apparatus 200 may be set up to transmit the remaining-developer information arranged with respect to a predetermined reference item to a predetermined user. The transmission of the remaining-developer information may be achieved by a user's selection, periodically, or randomly.

The controller 250 performs general controls for the host apparatus 200. The controller 250 controls the display unit 220 to display the remaining-developer information received from the device administration server 100. If the user selects at least one of the remaining-developer information as the reference item through the user interface 210, the controller 250 controls the display unit 220 to display the remaining-developer information arranged in the ascending or descending order with respect to the selected reference item.

The controller 250 may control the storage unit 240 to store the arranged and displayed remaining-developer information. The storage unit 240 may store the remaining-developer information arranged and displayed on the remaining-developer display screen 30 as a temporary file, or as a file having a predetermined format such as CSV or the like at a designated location in response to a user' selection. The controller 250 may control the communication unit 240 to transmit the remaining-developer information arranged and stored in the storage unit 240 to the device administration server 100.

According to another aspect of the present invention, the controller 250 may send a seller the information about ordering a cartridge corresponding to color of a developer needing replacement based on the displayed remaining-developer information. Such information about ordering the cartridge may be automatically transmitted by a user's selection or a predetermined reference.

FIG. 6 shows a configuration of an image forming system according to an embodiment of the present invention. As shown in FIG. 6, an image forming system 10 in this embodiment includes a device administration server 100, a host apparatus 200 and at least one image forming apparatus 300-1, 300-2, . . . , 300-n. In the embodiments of the present invention shown in FIGS. 2 and 6, like numerals refer to like elements having the same functions, and descriptions about the corresponding elements are common to the embodiments of FIGS. 2 and 6.

The host apparatus 200 may be a personal computer (PC), a server such as the device administration server 100, a laptop, etc. If the administration server 100 is employed as the host apparatus 200, the image forming system 10 may not include a separate device administration server 100. At least one image forming apparatus 300-1, 300-2, . . . , 300-n may be achieved by a printer, a multi-function peripheral having two or more functions, etc., in each of which network connection is possible.

The device administration server 100 includes a first storage unit 130, a first communication unit 140, and a first controller 150. The first controller 150 receives remaining-developer information from at least one image forming apparatus 300-1, 300-2, . . . , 300-n through the first communication unit 140 and stores the remaining-developer information in the first storage unit 130. The first controller 150 controls the first communication unit 140 to send the host apparatus 200 the remaining-developer information of at least one image forming apparatus 300-1, 300-2, . . . , 300-n stored in the first storage unit 130.

The device administration server 100 may include an application server and/or a web server connectable with the host apparatus 200 and at least one image forming apparatus 300-1, 300-2, . . . , 300-n. If the device administration server 100 includes both the application server and the web server, the application server and the web server may be physically different from each other.

The host apparatus 200 connects with the device administration server 100 and receives the remaining-developer information from at least one image forming apparatus 300-1, 300-2, . . . , 300-n. A second controller 250 controls a second display unit 220 to display the remaining-developer information of each image forming apparatus 300-1, 300-2, . . . , 300-n received through a second communication unit 240.

If at least one reference item is selected among the sorting items of the remaining-developer information in the remaining-developer display screen 30 through a second user interface 210, the second controller 250 controls the second display unit 220 to arrange and display the remaining-developer information with reference to the selected reference item. The sorting item of the remaining-developer information to be used as the reference item is one of the developer colors C, M, Y and K, which can be arranged in the ascending or descending order with respect to the reference item.

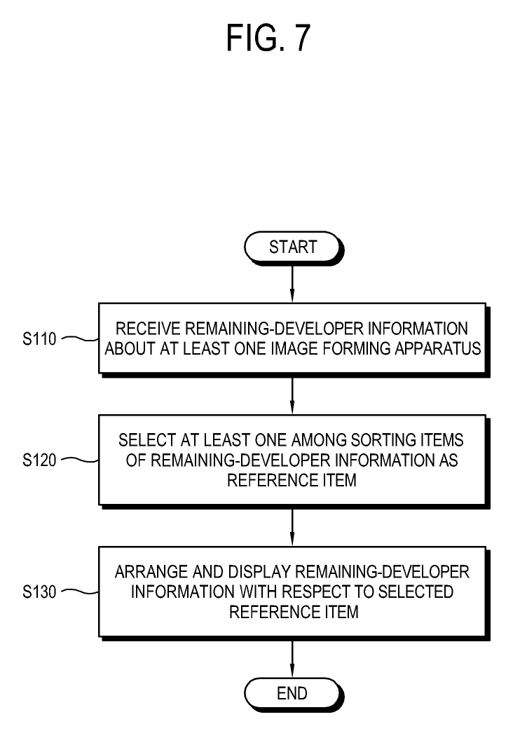

A remaining-developer display method will be described with reference to FIG. 7 and the above-described configuration. At operation S210, the host apparatus 200 connects with the device administration server 100 or at least one image forming apparatus 300-1, 300-2, . . . , 300-n, and receives the remaining-developer information about at least one image forming apparatus 300-1, 300-2, . . . , 300-n. The developer includes a toner, ink, or the like, in which the toner or the ink may correspond to black or one or more colors.

At operation S220, the host apparatus 200 selects one or more of the sorting items of the remaining-developer information received in the operation S210 through the user interface 210 as the reference item. The sorting item may be one of the developer colors, such as C, M, Y and K.

At operation S230, the host apparatus 200 arranges and displays the remaining-developer information with respect to the selected reference item. The remaining-developer information sorted according to colors may be displayed as a column, and arranged in the ascending or descending order with respect to the selected reference item.

According to aspects of the present invention, the host apparatus 200 dynamically arranges and displays the remaining-developer information about at least one image forming apparatus 300-1, 300-2, . . . , 300-n, so that a user can easily grasp the amount of the remaining-developer at a glance. Further, a user may edit the arranged developer information as desired and then store and transmit the developer information.

According to aspects of the present invention described above, there are provided a host apparatus connecting with an image forming apparatus, an image forming system having the same and a remaining-developer display method, in which remaining-developer information are dynamically arranged and displayed with regard to at least one image forming apparatus, so that a user can easily grasp the amount of the remaining developer at a glance.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of displaying a remaining-developer in a host apparatus connectable with at least one image forming apparatus, the method comprising:
receiving remaining-developer information about the at least one image forming apparatus;
selecting one or more sorting items displayed corresponding to the received remaining-developer information as a reference item; and
arranging and displaying the remaining-developer information with reference to the selected reference item.

2. The method according to claim 1, wherein the arranging and displaying of the remaining-developer information comprises displaying the remaining-developer information sorted according to the sorting items as a column.

3. The method according to claim 1, wherein the arranging and displaying of the remaining-developer information comprises arranging and displaying the remaining-developer information in ascending or descending order with reference to the selected reference item.

4. The method according to claim 1, wherein the sorting item comprises four or more colors.

5. The method according to claim 1, wherein the receiving of the remaining-developer information about the at least one image forming apparatus comprises:
accessing a device administration server in which the remaining-developer information of the at least one image forming apparatus is stored; and
receiving the remaining-developer information from the device administration server.

6. The method according to claim 1, further comprising:
selecting one or more of the sorting items as a filtering item,
wherein the arranging and displaying of the remaining-developer information comprises filtering off the selected filtering item.

7. The method according to claim 1, further comprising adding or deleting one or more of the at least one sorting item of the remaining-developer information.

8. The method according to claim 1, further comprising transmitting information about ordering a cartridge corresponding to color of a developer needing replacement based on the displayed remaining-developer information.

9. A host apparatus connectable with at least one image forming apparatus, comprising:
a communication unit to receive remaining-developer information about the at least one image forming apparatus;
a user interface through which one or more sorting items displayed corresponding to the received remaining-developer information are selected as a reference item;
a display unit to display the received remaining-developer information; and
a controller to control the display unit to arrange and display the remaining-developer information with reference to the selected reference item.

10. The host apparatus according to claim 9, wherein the display unit displays the remaining-developer information sorted as a column according to the sorting items.

11. The host apparatus according to claim 9, wherein the display unit arranges and displays the remaining-developer information in ascending or descending order with reference to the selected reference item.

12. The host apparatus according to claim 9, wherein the sorting item comprises four or more colors.

13. The host apparatus according to claim 9, wherein the communication unit accesses a device administration server in which the remaining-developer information of the at least one image forming apparatus is stored, and receives the remaining-developer information from the device administration server.

14. The host apparatus according to claim 9, wherein:
one or more of the sorting items is selected as a filtering item through the user interface, and
the display unit displays the remaining-developer information by filtering off the selected filtering item.

15. The host apparatus according to claim 9, wherein one or more of the at least one sorting item of the remaining-developer information is added or deleted through the user interface.

16. The host apparatus according to claim 9, wherein the communication unit transmits information about ordering a cartridge corresponding to a color of a developer needing replacement based on the displayed remaining-developer information.

17. An image forming system comprising at least one image forming apparatus, a device administration server and a host apparatus,
the device administration server comprising:
a first communication unit to communicate with the image forming apparatus and the host apparatus;
a storage unit; and
a first controller to receive remaining-developer information from the at least one image forming apparatus and to store the remaining-developer information in the storage unit, and
the host apparatus comprising:
a second communication unit to access the device administration server and to receive the remaining-developer information about the at least one image forming apparatus from the device administration server;
a user interface through which one or more sorting items are displayed corresponding to the received remaining-developer information as a reference item;
a display unit to display the received remaining-developer information; and
a second controller to control the display unit to arrange and display the remaining-developer information with respect to the selected reference item.

18. An image forming system comprising at least one image forming apparatus and a host apparatus,
the host apparatus comprising:
a communication unit to receive remaining-developer information from the at least one image forming apparatus;
a user interface through which one or more sorting items are displayed corresponding to the received remaining-developer information as a reference item;
a display unit to display the received remaining-developer information; and
a controller to control the display unit to arrange and display the remaining-developer information with respect to the selected reference item.

19. A device administration server connected to at least one image forming apparatus, the device administration server comprising:
a communication unit to communicate with the at least one image forming apparatus and a host apparatus;
a controller to request information about a remaining developer from one or more of the at least one image forming apparatus, to arrange the receiving remaining-developer information in a predetermined order based on user input received from the host apparatus, and to transmit the arranged remaining-developer information to the host apparatus for display on a display unit; and
a storage unit to store the remaining-developer information received from the at least one image forming apparatus,
wherein the controller is a web server.
